(19) United States
(12) Patent Application Publication
(10) Pub. No.: US 2013/0338280 A1
(43) Pub. Date: Dec. 19, 2013

(54) Flame Retardant Material with Orthogonally Functional Capsules

(71) Applicants: Dylan J. Boday, Tucson, AZ (US); Joseph Kuczynski, Rochester, MN (US); Jason T. Wertz, Wappingers Falls, NY (US)

(72) Inventors: Dylan J. Boday, Tucson, AZ (US); Joseph Kuczynski, Rochester, MN (US); Jason T. Wertz, Wappingers Falls, NY (US)

(73) Assignee: INTERNATIONAL BUSINESS MACHINES CORPORATION, Armonk, NY (US)

(21) Appl. No.: 13/527,128

(22) Filed: Jun. 19, 2012

(51) Int. Cl. C08L 61/34; C08L 77/00; C08L 75/02; C08K 5/10; C08L 67/00; C08K 5/521; C08K 3/22; C08K 5/5397; C08L 69/00; C08L 75/04

(52) U.S. Cl. 524/143; 524/537; 524/538; 524/539; 524/541; 524/437; 524/436; 524/409; 524/147; 524/144; 524/148; 524/315

(57) ABSTRACT

A flame retardant capsule may contain a flame retardant, a polymer shell encapsulating the flame retardant, and at least one functional group orthogonal to the surface of the polymer shell. This flame retardant capsule may be covalently bonded into a polymeric material by the orthogonal functional group. The flame retardant capsules may be formed through microencapsulation.

### TECHNICAL FIELD

This invention relates to the field of flame retardant materials. More particularly, it relates to the field of flame retardants, encapsulated by a polymer, and containing orthogonal functional groups covalently bonded into a polymeric matrix.

### BACKGROUND

Polymeric materials are used in many applications, including paints, upholstery, pipes, and circuit boards. Polymeric materials can undergo degradation due to a number of factors, including heat, chemicals, and mechanical forces.

### SUMMARY

In one embodiment, a material for releasing a dispersive agent includes a polymeric substrate and a capsule dispersed in the polymeric substrate. The capsule may have a polymer shell, a dispersive agent enclosed in the capsule, and an orthogonal functional group attached to the capsule and covalently bonded with the polymeric substrate.

In another embodiment, a method for creating a dispersive material includes creating a microemulsion containing a continuous phase and a dispersed phase, and initiating polymerization to create a polymer capsule with orthogonal functional groups. The continuous phase may include monomers having one or more orthogonal functional groups, and the dispersed phase may include a dispersive agent.

In another embodiment, a method for creating a dispersive material includes receiving orthogonally functional capsules containing a dispersive agent and covalently bonding the capsules into a polymeric substrate.

### BRIEF DESCRIPTION OF THE DRAWINGS

Embodiments are illustrated by way of example, and not by way of limitation, in the figures of the accompanying drawings in which reference numerals refer to similar elements.

FIG. 1A depicts a capsule without a polymeric surfactant, while FIG. 1B depicts a capsule with a polymeric surfactant, according to embodiments of the invention.

FIG. 2 illustrates capsule rupture, according to embodiments of the invention.

FIG. 3 depicts formation of a capsule, according to embodiments of the invention.

### DETAILED DESCRIPTION

Polymeric materials may undergo degradation due to a number of factors, including heat, chemicals, and mechanical forces. When a polymeric material is exposed to a heat source, the polymeric material may become damaged through melting, cracking, ignition, or other method of degradation. This damage may lead to equipment failure in circuit boards, fluid piping systems, and other applications with polymeric materials.

According to embodiments of the invention, a capsule may contain a flame retardant which may help to inhibit the spread or severity of a fire. The capsule may include a polymer shell encapsulating the flame retardant and at least one functional group substantially orthogonal to the surface of the polymer shell, where substantially orthogonal refers to an orientation away from the surface of the polymer shell. The functional group orthogonal to the surface of the polymer shell may be referred to in this Description and in the Claims as an “orthogonal functional group.”

A flame retardant capsule may be covalently bonded into a polymeric material by an orthogonal functional group. Encapsulating the flame retardant into a capsule may help prevent the flame retardant from leaching out of the polymeric material, and covalently bonding the capsules into a polymeric material may make the flame retardant material more effective as a flame retardant due to increased likelihood of capsule rupture in the event of a fire. Flame retardants are often hazardous to the environment, and encapsulation of the flame retardant may help prevent leaching of the flame retardant out of the polymeric material. It is also important for flame retardant capsules having dispersive flame retardants to rupture, so as to release the flame retardant into the polymeric material. The covalent bonding of the capsules into the polymeric material may improve the rupture characteristics of the capsule so that the capsule is more likely to rupture during a catastrophic event caused by fire or heat.

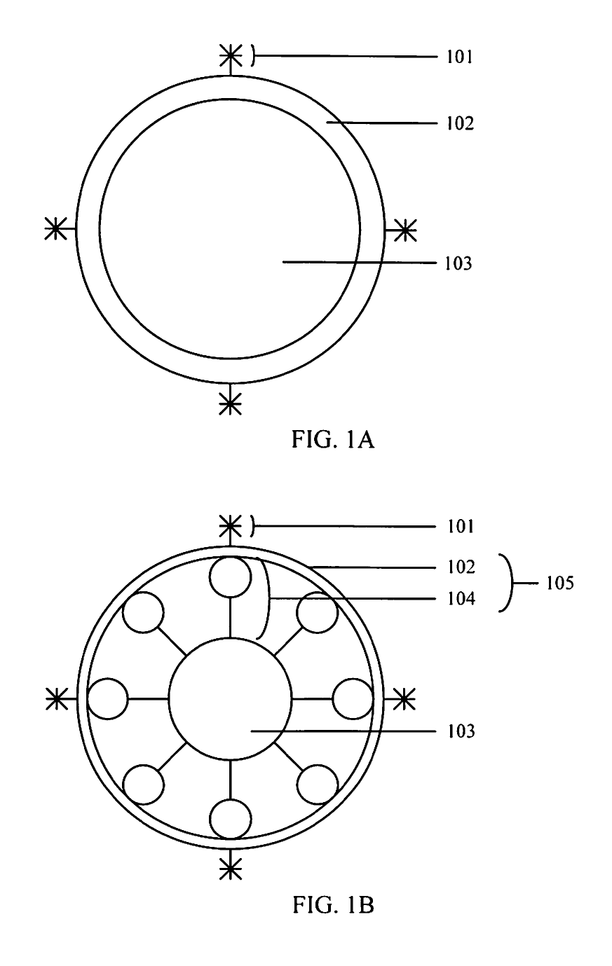

FIG. 1A depicts a capsule used in a flame retardant material, according to an embodiment of the invention. A flame retardant 103 is encapsulated by a polymer layer 102. Attached to the polymer layer 102 is a functional group 101 substantially orthogonal to the surface of the polymer layer 102.

### Flame Retardant and Dispersion Mechanisms

According to embodiments of the invention, capsules containing a flame retardant may inhibit fire or combustion on or near a polymeric material. In one embodiment of the invention, a flame retardant contained within a capsule may inhibit combustion of a polymeric material before rupture of the capsule. For example, the flame retardant may absorb heat from the surrounding polymer to retard combustion.

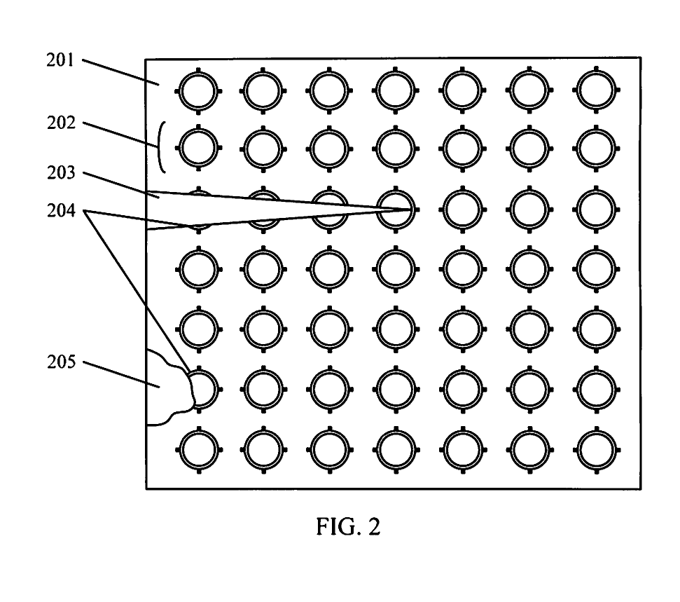

In another embodiment of the invention, a flame retardant contained within a capsule may inhibit combustion upon or after rupture of the capsule. A rupture of the capsule may be caused by a crack in the polymeric material, degradation of the polymeric material, or any other method of decomposition of the polymeric material or capsule which ruptures the capsule. FIG. 2 represents a two dimensional cross-sectional diagrammatic representation of a polymeric material having capsules that contain a flame retardant, according to embodiments of the invention. FIG. 2 illustrates how a crack 203 and a degraded portion 205 may lead to the rupture of some of the capsules 202. The capsules 202 are embedded in and covalently bonded with a polymeric material 201 through orthogonal functional groups on the capsules. When a crack 203 forms or degraded portion 205 occurs, it may create a capsule rupture 204, causing a flame retardant to flow into the crack 203 or degraded portion 205.

According to embodiments of the invention, a flame retardant dispersed from a ruptured capsule in a polymeric material may inhibit the spread of fire through any mechanism that helps to prevent combustion of the polymeric material or surrounding materials. Flame retardants may work through physical mechanisms which include, but are not limited to, coating the polymer material's surface or diluting elements in the polymeric material's vicinity that are required for combustion. For example, the flame retardant may be a fast-curing polymer with a higher combustion temperature than the surrounding polymeric material. Flame retardants may also work through chemical reactions that inhibit combustion or alter the surrounding polymeric material. For example, the fire retardant may cause the surrounding polymeric material to form a fire-resistant carbon layer which inhibits the spread of a fire.

The dispersive flame retardants that may be used include, but are not limited to, cresyl diphenyl phosphate, HCFC 123, HFC-236fa, pentafluorethane, HFC-227ea, HFC-23, aluminum hydroxide, magnesium hydroxide, organobromines, organochlorines, antimony trioxide, boron compounds, tetrakis(hydroxymethyl)phosphonium salts, chloronated paraffins, tri-o-crsyl phosphate, tris(2,3-dibromopropyl)phosphate, bis(2,3-dibromopropyl)phosphate, and tris(1-aziridinyl)-phosphine oxide. A flame retardant compound may be bonded to another compound, so as to give the flame retardant the desired physical properties for the application, such as boiling point and viscosity.

While this disclosure has so far been directed toward a flame retardant encapsulated in a capsule having an orthogonal functional group, the principles of the invention are not limited to flame retardants, and the capsule may contain any substance or agent that may be dispersed upon capsule rupture. In embodiments of the invention, the capsule may contain any dispersive agents for dispersion upon rupture of the capsule which include, but are not limited to, dyes, lubricants, fuels, and markers.

### Capsule Structure and Formation

According to embodiments of the invention, the flame retardant capsules may be formed through microencapsulation. Microencapsulation methods may include in situ polymerization and interfacial polymerization. Both of these methods of polymerization are based on emulsion systems.

In an embodiment of the invention, a capsule is formed through interfacial polymerization. Interfacial polymerization involves polymerization of one or more reactant monomers at the interface of two liquid phases, the continuous phase and dispersed phase. One or more monomers from the dispersed phase polymerize with one or more monomers from the continuous phase at the interface of the two phases. The rate of polymerization exceeds the rate of diffusion of the newly formed polymer away from the interface, and the polymer condenses at the interface of the two phases, forming a wall between the aqueous phase and dispersed phase.

In another embodiment of the invention, a flame retardant capsule is formed through in situ polymerization. In situ polymerization involves a process similar to interfacial polymerization, except that no reactant monomers are part of the dispersed phase. Like interfacial polymerization, in situ polymerization occurs at the interface of the continuous and dispersed phases; however, only monomers in the continuous phase polymerize. This polymerization forms a capsule wall between the continuous and dispersed phases.

In one embodiment of the invention, a polymeric surfactant is dispersed in water to form an aqueous solution. A monomer and cross-linking agent are added to the aqueous solution, where the cross-linking agent has a functional group. A flame retardant is added to the aqueous solution to form a dispersion, where the flame retardant forms the dispersed phase and the aqueous solution forms the continuous phase. The polymeric surfactant surrounds the flame retardant and forms a micelle. A condensing agent is added to the dispersion. The condensing agent forms a polymer with the monomer and cross-linking agent at the interface of the micelle and aqueous phase, the polymer surrounding the flame retardant and polymeric surfactant, and forming a capsule. By selecting a cross-linking agent having a functional group, the cross-linking agent may be integrated into the polymer and the functional group may be oriented on the surface of the capsule, making the functional group available for covalent bonding into a polymeric substrate. The resulting capsule contains the flame retardant and polymeric surfactant enclosed in the capsule, a polymer shell, and an orthogonal functional group on the surface of the capsule.

FIG. 1B depicts the structure of a capsule formed by the in situ polymerization mechanism discussed above, according to an embodiment of the invention. A flame retardant 103 is encapsulated by a polymeric surfactant 104, which forms a membrane around the flame retardant 103. A polymer layer 102 deposits onto the polymeric surfactant 104. Together, the polymer layer 102 and the polymeric surfactant 104 form a capsule 105 around the flame retardant 103. A functional group 101 is created substantially orthogonal to the polymer layer 102.

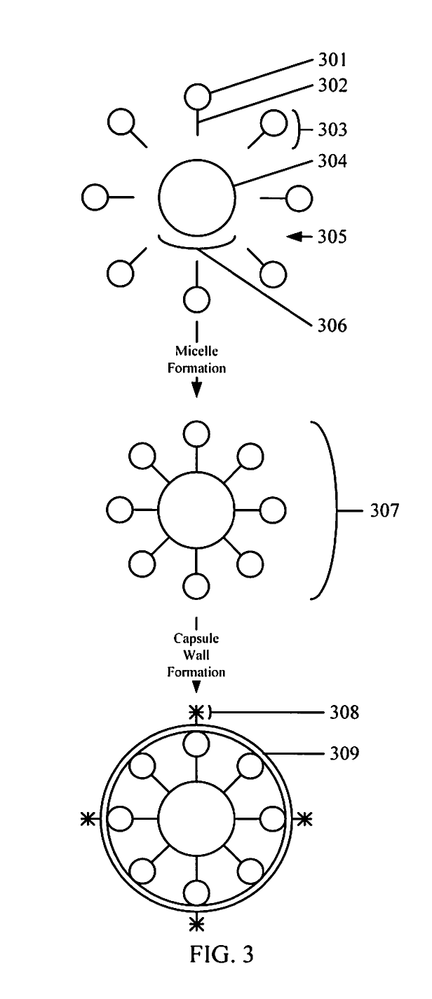

FIG. 3 depicts capsule formation through in situ polymerization in an oil-in-water microemulsion, according to an embodiment of the invention. A flame retardant 304 is dispersed into a solution to form a dispersed phase 306, the dispersed phase contained in a continuous phase 305. A surfactant 303 having a polar end 301 and a non-polar end 302 is present in the microemulsion. The non-polar end 302 is attracted to the flame retardant 304 to form a micelle 307. Monomers and cross-linking agents are dispersed into the solution. The capsule wall 309 is formed by initiating polymerization of the monomers and cross-linking agents in the continuous phase 305, with the polymer depositing at the polar end 301 of the surfactant. The cross-linking agent contains a functional group 308 which, after capsule wall formation, is oriented substantially orthogonally from the capsule wall 309.

In another embodiment of the invention, a flame retardant is contained within a polymer shell formed from urea, formaldehyde, and resorcinol-group copolymers. A flame retardant is surrounded by a surfactant, in this case a polymeric emulsifying agent. Urea and formaldehyde form a shell around this polymeric emulsifying agent. The urea-formaldehyde polymer formation is as follows:

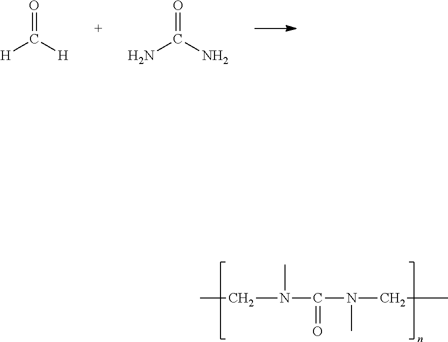

As the urea-formaldehyde polymer forms, it condenses at the interface of the continuous and dispersed phases, forming a shell around the dispersed phase. The resorcinol-group copolymer acts as a cross-linking agent to the urea-formaldehyde polymers, forming part of the polymer shell. The polymeric emulsifying agent acts as a site at which the urea-formaldehyde-resorcinol polymer condenses. For example, in an embodiment of the invention, if the polymeric emulsifying agent is ethyl methacrylate, the urea-formaldehyde-resorcinol shell will form at the carboxyl groups of the ethyl methacrylate. This resorcinol-group copolymer also contains an orthogonal functional group. After formation of the urea-formaldehyde-resorcinol shell, the shell contains orthogonal functional groups on its surface for bonding into a polymeric substrate.

In various embodiments of the invention, other monomers and condensing agents may be used to form a polymer shell. These other monomers and condensing agents may include, but are not limited to, melamine, polyamine, phenol, and acetaldehyde.

The flame retardant capsules may be controlled for size, both for the capsule and the capsule shell. The thickness of the capsule shell may be controlled by the concentration of the monomers in the polymerization reaction, the temperature of the polymerization reaction, and length of time the polymerization reaction is allowed to continue, as well as other general factors dictating chemical reactions. It may be desirable to have a thinner capsule wall, depending on the properties of the polymeric material into which the flame retardant capsule is bonded or the application of the polymeric material. For example, the capsules may be from 10-100 microns thick, depending on factors such as the properties and application of the surrounding polymeric material.

### Orthogonal Functionality and Polymeric Substrate

Once the flame retardant capsules are formed, they may be dispersed into a polymeric substrate. Orthogonal functional groups on the flame retardant capsules enable the capsules to covalently bond directly into the polymeric substrate's matrix. For example, the capsule may have allyl functional groups, which would allow it to be integrated into a polystyrene polymer matrix.

In an embodiment, flame retardant capsules are formed with orthogonally functional cross-linking agents, which may be any cross-linking agents with functional groups that create orthogonal functional groups on the capsule once the capsule is formed. The orthogonally functional cross-linking agent may be a resorcinol compound with a functional group, such as an allyl. For example, an oxygen atom in a hydroxyl group of phloroglucinol may bond with the first position carbon in allyl chloride to form resorcinol with a propenyloxy group as shown below. The two hydroxyl groups of the resorcinol compound may still be available for cross-linking.

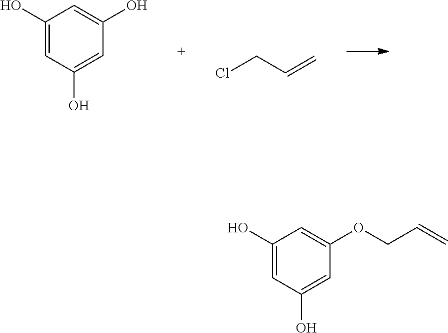

Orthogonal functional groups attached to the flame retardant capsules may be selected based on composition of the polymeric substrate in which the flame retardant capsule will be incorporated. For example, if the polymeric substrate is a polyamide, the orthogonal functional group attached to the flame retardant capsule may be an amide group. The orthogonal functional groups that may be used include, but are not limited to, allyls, esters, epoxies, acrylates, amides, amines, urethanes, urea, siloxane, carbonates, sulfides, ethers, and aldehydes. Additionally, the orthogonal functional group introduced by the cross-linking agent can be further modified with an alternative functional group, including any of the aforementioned functional groups, so that the functional group used for bonding into the polymeric substrate may be different from the functional group attached to the orthogonally functional cross-linking agent. An alternative functional group may be added to a functional group of a cross-linking agent before capsule formation or added to an orthogonal functional group of a flame retardant capsule after capsule formation.

An orthogonal functional group may covalently bond into a surrounding polymeric substrate. This covalent bonding promotes adhesion of the capsule wall to the polymeric substrate surrounding the capsule so that in the event of a crack or other decomposing event, this increased adhesion may cause greater capsule deformation than might otherwise occur with a capsule not covalently bonded to the substrate. An orthogonal functional group acts as an anchor into the polymeric substrate, so that when a crack propagates through the polymeric substrate, flame retardant capsules along and near the crack may be pulled by the separating crack faces, and the tension caused by opposing forces may cause the capsule wall to break. Any flame retardant capsule that is near enough to the crack or other areas of deformation such that the associated forces are sufficiently strong may rupture or break. For example, if the tension to break a capsule is X tension and the adherence between the capsule and the polymeric substrate is ½ X tension, as may be found in a capsule not covalently bonded into a substrate, the capsule may not break and the crack may circumvent the capsule. However, if the adherence between the capsule and the polymeric substrate is increased to 2 X tension through covalent bonding of the capsule to the polymeric substrate through one or more orthogonal functional groups, the capsule is likely to break and release flame retardant into the crack.

According to embodiments of the invention, a flame retardant capsule may be incorporated into a variety of polymeric substrates. The polymeric substrates include, but are not limited to, polyesters, polyamides, polyurethane, polyurea, polysiloxane, polycarbonates, polysulfides, polyethers, and phenol formaldehydes. The type of polymer to be used will depend on the type of orthogonal functional group attached to the flame retardant capsule, and vice versa. The polymeric substrates may be formed by any suitable method, including step growth, chain growth, or controlled growth polymerization methods.

The flame retardant capsules may be dispersed into the polymeric substrate through any suitable method of dispersion and polymer formation, such as colloidal dispersions. In an embodiment of the invention, the flame retardant capsules are dispersed into a monomer solution, after which polymerization of the monomer solution is initiated. The flame retardant capsules may form covalent bonds with other polymers, becoming part of the polymer matrix.

### Experimental Protocols

The following illustrative experimental protocols are prophetic examples which may be practiced in a laboratory environment.

### Formation of Orthogonally Functional Resorcinol, Phloroglucinol, Allyl Chloride

Solution A contains phloroglucinol and water. Solution B contains allyl chloride, triethyl amine, and tetrahydrofuran (THF). Solution B is added to solution A and kept in a cold bath at 0° C.

### Formation of Flame Retardant Capsule; EMA Copolymer, URF Shell

Solution A is an aqueous solution containing 2.5 g urea, 0.25 g ammonium chloride, 25 mL EMA copolymer, and 0.25 g resorcinol with an orthogonal functionality. The pH of Solution A is adjusted to 3.5 through the addition of sodium hydroxide and hydrochloric acid. A flame retardant and a polymeric solvent, silicone oil, are added to Solution A to form Solution B. 6.33 g formalin is added to Solution B, forming microcapsules. The microcapsules are washed and sieved.

Formation of Flame Retardant Material; Flame Retardant Capsules with Amine Functional Groups, Polyetheramine Polymer Matrix. Aliphatic Polyisocyanate

4.50 g of Basonat® HI-100 (aliphatic polyisocyanate) and 225 mg flame retardant capsules having orthogonal amine functional groups are added to 100 ml of acetone in a 250 ml plastic flask. 26.5 g Jeffamine® D-2000 (polyetheramine) are added to 75 ml of acetone in a 250 ml plastic flask. The two solutions are mixed and stirred for 5 minutes, dispersed onto a flat glass surface, and left to dry for 24 hours.

While the present invention has been described with reference to the details of the embodiments of the invention shown in the drawings, these details are not intended to limit the scope of the invention as claimed in the appended claims.

What is claimed is:

1. A material for releasing a dispersive agent, comprising:
a polymeric substrate;
a capsule having a polymer shell;
a dispersive agent enclosed in the capsule;
an orthogonal functional group attached to the capsule and covalently bonded with the polymeric substrate, wherein the orthogonal functional groups promote rupture of the capsule in response to deformation of the material near the capsule.

2. The material of claim 1, wherein the polymer shell is derived from a polymer of urea, formaldehyde, and resorcinol compounds having orthogonal functional groups.

3. The material of claim 1, wherein the dispersive agent is a flame retardant.

4. The material of claim 3, wherein the flame retardant is selected from the group consisting of cresyl diphenyl phosphate, HCFC 123, HFC-236fa, pentafluorethane, HFC-227ea, HFC-23, aluminum hydroxide, magnesium hydroxide, organobromines, organochlorines, antimony trioxide, boron compounds, tetrakis(hydroxymethyl)phosphonium salts, chloronated paraffins, tri-o-crsyl phosphate, tris(2,3-dibromopropyl)phosphate, bis(2,3-dibromopropyl)phosphate, and tris(1-aziridinyl)-phosphine oxide.

5. The material of claim 1, wherein the polymeric substrate is a step growth, chain growth, or controlled growth polymer.

6. The material of claim 1, wherein the polymeric substrate is from the group consisting of polyesters, polyamides, polyurethane, polyurea, polysiloxane, polycarbonates, polysulfides, polyethers, and phenol formaldehydes.

7. The material of claim 1, wherein the orthogonal functional group is from the group consisting of allyls, vinyls, esters, epoxies, acrylates, amides, amines, urethanes, urea, siloxane, alkoxysilanes, isocyanates, carbonates, sulfides, ethers, and aldehydes.

8. A method for creating a material, comprising:
creating a microemulsion, including a continuous phase and a dispersed phase, the continuous phase including first monomers, wherein the first monomers have one or more orthogonal functional groups, and the dispersed phase including a dispersive agent; and
initiating polymerization to create a polymer capsule with orthogonal functional groups.

9. The method of claim 8, wherein the continuous phase further comprises second monomers.

10. The method of claim 9, wherein the first monomers are resorcinol compounds, the second monomers are urea, and the initiation of polymerization includes adding formaldehyde to the microemulsion.

11. The method of claim 10, wherein the microemulsion further comprises a surfactant.

12. The method of claim 11, wherein the surfactant is ethyl methacrylate.

13. The method of claim 8, wherein the dispersive agent is a flame retardant.

14. The method of claim 13, wherein the flame retardant is selected from a group consisting of cresyl diphenyl phosphate, HCFC 123, HFC-236fa, pentafluorethane, HFC-227ea, HFC-23, aluminum hydroxide, magnesium hydroxide, organobromines, organochlorines, antimony trioxide, boron compounds, tetrakis(hydroxymethyl)phosphonium salts, chloronated paraffins, tri-o-crsyl phosphate, tris(2,3-dibromopropyl)phosphate, bis(2,3-dibromopropyl)phosphate, and tris(1-aziridinyl)-phosphine oxide.

15. A method for making a material, comprising:
combining monomers and capsules including a dispersive agent, with orthogonal functional groups attached to the capsules; and
initiating polymerization of the monomers.

16. The method of claim 15, wherein the flame retardant capsules further comprise a surfactant.

17. The method of claim 15, wherein polymerization is initiated through step growth, chain growth, or controlled growth polymerization.

18. The method of claim 15, wherein the monomers are selected from a group consisting of esters, amides, urethanes, urea, siloxane, carbonates, sulfides, ethers, and phenol formaldehydes.

19. The method of claim 15, wherein the orthogonal functional groups are selected from the group of allyls, vinyls, esters, epoxies, acrylates, amides, amines, urethanes, urea, siloxane, alkoxysilanes, isocyanates, carbonates, sulfides, ethers, and aldehydes.

20. The method of claim 15, wherein the dispersive agent is a flame retardant.

21. The method of claim 20, wherein the flame retardant is selected from a group consisting of cresyl diphenyl phosphate, HCFC 123, HFC-236fa, pentafluorethane, HFC-227ea, HFC-23, aluminum hydroxide, magnesium hydroxide, organobromines, organochlorines, antimony trioxide, boron compounds, tetrakis(hydroxymethyl)phosphonium salts, chloronated paraffins, tri-o-crsyl phosphate, tris(2,3-dibromopropyl)phosphate, bis(2,3-dibromopropyl)phosphate, and tris(1-aziridinyl)-phosphine oxide.
